(19) United States
(12) Patent Application Publication
(10) Pub. No.: US 2026/0352001 A1
(43) Pub. Date: Nov. 5, 2026

(54) BATTERY CHARGER AND METHOD OF CHARGING A BATTERY

(71) Applicant: Dyson Technology Limited, Malmesbury, Wiltshire (GB)

(72) Inventor: Marcos BATISTA KETZER, Swindon (GB)

(21) Appl. No.: 19/105,089

(22) PCT Filed: Aug. 15, 2023
(86) PCT No.: PCT/IB2023/058189

§ 371 Date: Feb. 20, 2025

(30) Foreign Application Priority Data
Aug. 23, 2022 (GB) 2212249.3

(51) Int. Cl. H02J 7/60; H02J 7/44; H02J 7/61; H02J 7/80; H02J 7/90; H02M 1/00; H02M 1/34; H02M 3/335

(52) U.S. Cl. CPC H02J 7/685; H02J 7/44; H02J 7/61; H02J 7/80; H02J 7/933; H02M 1/0009; H02M 1/0032; H02M 1/34; H02M 3/33507

(57) ABSTRACT

A battery charger includes a transformer having a primary winding and a first secondary winding. Current-modulating circuitry is coupled in series with the primary winding, and battery detection circuitry is coupled to the first secondary winding and configured to output a connection status signal. Control circuitry is coupled to receive the connection status signal, and to control the current-modulating circuitry at least partly in reliance on the connection status signal, thereby to control energisation of the primary winding. When the battery charger is in a standby mode, a change in an output of the first secondary winding responsive to coupling of the battery to the battery charger causes the battery detection circuitry to change the connection status signal, which switches the battery charger from the standby mode to a charging mode. An associated method and battery are also disclosed.

### TECHNICAL FIELD

The present invention relates to a battery charger, and a method of charging a battery.

### BACKGROUND

Battery chargers are used to charge rechargeable batteries. Typically, such chargers are plugged into a mains power supply. A battery is coupled to the charger, and charged in accordance with a charging scheme, such as a constant-current, constant voltage scheme.

It is generally desirable to reduce the amount of power consumed by battery chargers, especially while in standby mode, and to simplify and/or reduce the cost of battery charger circuitry.

### SUMMARY

In a first aspect, there is provided a battery charger comprising:
a transformer comprising:
   a primary winding; and
   a first secondary winding;
current-modulating circuitry coupled in series with the primary winding;
battery detection circuitry coupled to the first secondary winding and configured to output a connection status signal; and
control circuitry coupled to receive the connection status signal, and to control the current-modulating circuitry at least partly in reliance on the connection status signal, thereby to control energisation of the primary winding;
wherein, when the battery charger is in a standby mode in which the control circuitry controls the current-modulating circuitry to generate standby pulses in the primary winding, a change in an output of the first secondary winding responsive to coupling of the battery to the battery charger causes the battery detection circuitry to change the connection status signal, the change in the connection status signal switching the battery charger from the standby mode to a charging mode, in which the control circuitry controls the current-modulating circuitry to generate power pulses in the primary winding, wherein the power pulses are of higher average power than the standby pulses.

Using a connection status signal to control switching between standby and charging modes in this way may allow for reduced standby power consumption, and/or reduced or simpler circuitry.

The connection status signal may comprise a voltage that increases responsive to the coupling of the battery to the battery charger. For example, the detection circuitry may comprise charge accumulating circuitry, the charge accumulating circuitry being configured to generate the connection status signal based on the pulses such that:
a voltage of the connection status signal as a result of the standby pulses when the battery is not connected is insufficient to cause the battery charger to switch from the standby mode into the charging mode; and
a voltage of the connection status signal as a result of the standby pulses when the battery is connected is sufficient to cause the battery charger to switch from the standby mode into the charging mode.

This may provide a convenient mechanism for controlling switching between the standby and charging modes.

The control circuitry may include a charging controller for controlling generation of the power pulses; and the connection status signal may be configured to power the charging controller during the charging mode. This may provide a convenient, simple and/or low-power mechanism for controlling the charging controller.

The battery charger may be configured to switch from the standby mode to the charging mode as a result of the charging controller being powered up due to an increase in voltage of the connection status signal. This may provide a convenient and/or simple mechanism for controlling the charging controller.

The charging controller may include:
a diode; and
a capacitor connected in series with the diode;
wherein the voltage of the connection status signal is a voltage generated at the capacitor based on current passing through the diode.

This may provide a convenient and/or simple mechanism for generating the connection status signal.

The control circuitry may comprise an oscillator or a pulse generator for generating the standby pulses. Optionally, the oscillator or pulse generator may be disabled when the battery charger is in the charging mode. This may help reduce power consumption when the charger is in the standby mode.

The oscillator or pulse generator may comprise an analogue oscillator circuit. Optionally, the analogue oscillator circuit may comprise an RC network. This may provide a convenient, simple, and/or low-power way of generating pulses in the standby mode.

The battery charger may be operable solely in a constant current charging mode. This may simplify the circuitry of the charger, especially when combined with one or more earlier optional aspects.

The battery charger may be configured to receive feedback indicative of a charging current, wherein during the charging mode, the battery is charged solely in a constant current mode, the charge current being controlled based on the feedback. This may simplify the circuitry of the charger compared to a charger that uses constant current, constant voltage charging, especially when combined with one or more earlier optional aspects.

The connection status signal may cause the battery charger to switch from the charging mode to the standby mode, responsive to the battery management system stopping charging of the battery as a result of a charge voltage reaching a predetermined threshold. This may provide a convenient and/or simple mechanism for stopping charging.

The battery charger may be configured such that the connection status signal causes the battery charger to repeatedly switch back and forth between the charging mode and the standby mode. This may provide a convenient and/or simple mechanism for ensuring complete charging of a battery.

The battery charger may comprise a second secondary winding, wherein the battery charger is configured to charge the battery via the second secondary winding.

The standby pulses in the primary winding may induce corresponding pulses in an output of the battery charger, the corresponding pulses being detectable by a battery management system (BMS) of a battery upon coupling of the battery to the battery charger for charging.

According a second aspect, there is provided a method of charging a battery using a battery charger comprising a transformer having a primary winding and a first secondary winding, the method comprising:
outputting a connection status signal based on an output of the first secondary winding, the output varying based on whether a battery is coupled to the battery charger for charging;
controlling the current-modulating circuitry based on the connection status signal, thereby to control energisation of the primary winding, such that the battery charger is operable in:
   a standby mode, in which standby pulses are generated in the primary winding; and
   a charging mode, in which power pulses are generated in the primary winding, wherein the power pulses are of higher average power than the standby pulses; and
responsive to a change in the connection status signal due to a change in the output of the first secondary winding upon coupling of the battery to the battery charger, switching the battery charger from the standby mode to the charging mode.

The method may comprise generating the connection status signal based on the pulses such that:
a voltage of the connection status signal as a result of the standby pulses when the battery is not connected is insufficient to cause the battery charger to switch from the standby mode into the charging mode; and
a voltage of the connection status signal as a result of the standby pulses when the battery is connected is sufficient to cause the battery charger to switch from the standby mode into the charging mode.

The method may comprise powering a charging controller of the battery charger with the connection status signal.

The method may comprise switching from the standby mode to the charging mode as a result of the charging controller being powered up due to an increase in voltage of the connection status signal.

According to a third aspect, there is provided a battery for use with the battery charger of any preceding claim.

The battery may comprise a bypass switch, the battery being configured to close the bypass switch upon coupling of the battery to a battery charger according to a previous aspect.

The battery may comprise a battery management system, the battery management system being configured to sense pulses at an output of the battery charger when the battery is coupled to the battery charger for charging.

The battery management system may be configured to close the bypass switch responsive to sensing of the pulses at the output of the battery charger, when the battery management system determines that the battery requires charging.

Features described above in connection with any aspect of the invention are equally applicable to all other aspects of the invention.

### BRIEF DESCRIPTION OF THE DRAWINGS

FIG. 1 is schematic circuit diagram showing a battery charger and connected battery;

FIG. 2 is a schematic circuit diagram showing a further battery charger and connected battery;

FIG. 3 is a schematic circuit diagram showing a further battery charger and connected battery;

FIG. 4 is a signal diagram showing simulated operation of the battery charger of FIG. 3; and

FIG. 5 is a flowchart showing a method of charging a battery.

### DETAILED DESCRIPTION

Referring to FIG. 1, there is shown a battery charger 100. Battery charger 100 is for use in charging a lithium-ion battery-powered appliance (not shown), such as a rechargeable haircare appliance or a vacuum cleaner. However, the skilled person will appreciate that such a battery charger can also be used to charge other types of rechargeable devices, appliances, and battery packs, including those using different battery chemistries.

Battery charger 100 comprises a transformer 102. Transformer 102 comprises a primary winding 104, a first secondary winding in the form of auxiliary winding 106, and a second secondary winding 108. At least in relation to this particular implementation, transformer 102 take the form of a flyback transformer, in the sense that the core and windings are optimised for use in a flyback converter. In other implementations, the transformer can take any other suitable form.

Battery charger 100 includes current-modulating circuitry in the form of a field-effect transformer (FET) 110, the source and drain of which are coupled in series with primary winding 104. The skilled person will appreciate that other current-modulating circuitry can be used, including other semiconductor switches, and other active or passive components capable of modulating current.

Battery charger 100 includes battery detection circuitry 112, which is coupled to sense an output of auxiliary winding 106, and is arranged to output a connection status signal 114. As described in more detail below, the output of auxiliary winding 106 varies based on whether a battery is coupled to battery charger 100 for charging.

Battery charger 100 includes control circuitry 116, which is coupled to receive connection status signal 114. Control circuitry 116 is also connected to the gate of FET 110, so as to enable control circuitry 116 to control FET 110. The skilled person will appreciate that control circuitry 116 includes gate driver circuitry. As described in more detail below, FET 110 controls energisation of primary winding 104.

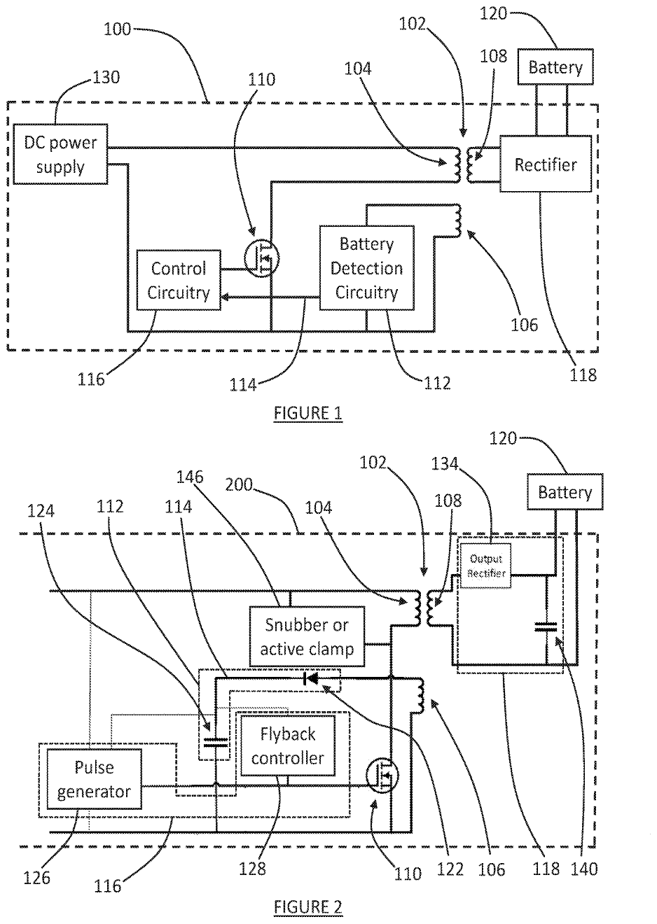

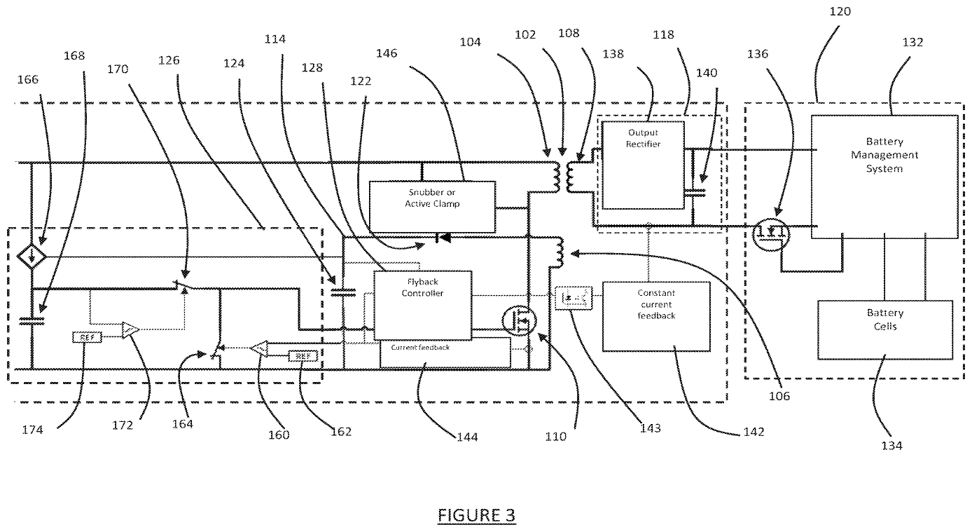

Control circuitry 116 can take any suitable form. For example, control circuitry 116 can include one or more microprocessors having one or more drive output(s) that control FET 110. Alternatively, one or more functions of control circuitry 116 can be performed with a dedicated analogue circuit, digital controller, or any suitable combination thereof. FIGS. 2 and 3 show example implementations, but the skilled person will appreciate that the required control can be implemented in many other ways.

Battery charger 100 includes AC to DC conversion circuitry 118 coupled for rectifying, and optionally filtering, an output of secondary winding 108.

Battery charger 100 includes a DC power supply 130 which can include, for example, a rectifier and filter (not shown). DC power supply 130 is powered by an AC mains power supply (not shown).

FIG. 1 shows a lithium-ion rechargeable battery 120 coupled for charging by battery charger 100. Battery 120 includes cells and, optionally, a battery management system, one implementation of which is described in relation to FIG. 3. In the implementation of FIG. 1, battery 120 is a battery pack that can be removed from the appliance (not shown) with which it is intended to be used, and temporarily coupled to battery charger 100 for charging, as shown in FIG. 1.

Battery charger 100 is operable in two modes. The first mode is a standby mode, in which control circuitry 116 controls FET 110 to generate standby pulses in primary winding 104. The second mode is a charging mode, in which control circuitry 116 controls FET 110 to generate power pulses in primary winding 104.

The power pulses are of higher average power than the standby pulses. For example, the energy of all standby pulses averaged across a given period may be lower than the energy of the pulses when the charger is in the charging mode averaged across a similar period. Optionally, the frequency of the pulses in the standby mode may be lower than those in the charging mode. This may help reduce the power of the standby pulses. Alternatively, or in addition, the peak voltage and/or current of the pulses in the standby mode may be lower than those in the charging mode. Alternatively, or in addition, the duration of the pulses in the standby mode may be shorter than those in the charging mode.

Control circuitry 116 is responsive to a change in connection status signal 114, upon coupling of 120 battery to battery charger 100, to switch battery charger 100 from the standby mode to the charging mode.

In use, battery charger 100 starts in standby mode, with battery 120 not being coupled for charging. Control circuitry 116 controls FET 110 such that a series of pulses are applied across primary winding 104. These pulses induce corresponding currents through auxiliary winding 106 and secondary winding 108. Battery detection circuit 112 determines that the output of auxiliary winding 106 is relatively low, meaning that battery 120 is not coupled for charging. As such, connection status signal 114 remains at a value indicating that battery 120 is not coupled to battery charger 100, and so battery charger 100 remains in the standby mode.

Battery detection circuit 112 can determine whether the output of auxiliary winding 106 is relatively low or high in any suitable manner. For example, an analogue to digital converter can be used to sample the output voltage of auxiliary winding 106, and the digital values output by analogue to digital converter processed to determine whether the voltage is high or low. For example, the digital values can be low-pass filtered, such as by way of a moving average. If the value of the moving average exceeds a threshold, battery detection circuit 112 can conclude that battery 120 has been coupled to battery charger 100 for charging.

Alternatively, connection status signal 114 can take the form of an analogue voltage. For example, connection status signal 114 can comprise a voltage that is higher (or higher on average) when battery 120 is coupled to battery charger 100 than when battery 120 is not coupled to battery charger 100.

The skilled person will appreciate that there are many other ways in which battery detection circuit 112 can determine, from the output of the first secondary winding (i.e., auxiliary winding 106 in the implementation of FIG. 1), whether battery 120 is coupled to battery charger 100 for charging. A particular implementation will be described in more detail below, with reference to FIGS. 2 and 3.

Next, battery 120 is coupled to battery charger 100 for charging. Upon being coupled in this way, battery 120 presents a voltage across secondary winding 108 (for example, during conduction of an output rectifier between battery 120 and secondary winding 108). This voltage across secondary winding 108 causes increased voltage/current within auxiliary winding 106, as a result of mirroring. As such, battery detection circuitry 112 determines that the output of auxiliary winding 106 is relatively high. Connection status signal 114 then changes to indicate that battery 120 is coupled to battery charger 100.

The change in connection status signal 114 causes battery charge 100 to switch from standby mode to charging mode. This involves control circuitry 116 changing the way in which FET 110 is controlled. In the implementation of FIG. 1, battery charger 100 uses flyback conversion. As such, to switch battery charger 100 to charging mode, control circuitry 116 stops outputting the pulses it was initially outputting, and instead outputs pulses of the sort ordinarily used to drive a flyback transformer, such as transformer 102. The pulses applied to primary winding 104 cause corresponding output pulses in secondary winding 108.

Optionally, the frequency of the flyback pulses is greater than the pulses that were output by control circuitry when battery charger 100 was in the standby mode.

The skilled person understands the operation of a flyback transformer in the context of a battery charger such as battery charger 100, and so the relationship between the flyback pulses applied to primary winding 104, and the output of secondary winding 108 will not be described in greater detail.

The output of secondary winding 108 is supplied to AC to DC conversion circuitry 118, which rectifies the output and supplies the result to battery 120, where it is used to charge cells within battery 120, optionally under the control of a BMS.

The charging can use a constant-current constant-voltage charging scheme, a solely constant current charging scheme, or any other suitable charging scheme. One implementation of a battery 120 having a BMS and battery cells is described below with reference to FIG. 3.

Battery charging can be terminated in any suitable manner. For example, a voltage of the battery cells of battery 120 can be measured by the BMS, and the charging terminated by the BMS once the desired voltage is reached. If a constant-current, constant-voltage is used, the charging is initially performed as a constant current. Once a first battery threshold voltage is reached, the charging switches from constant current to constant voltage. Charging continues at constant voltage until a second threshold voltage is reached, at which point charging is halted.

Other charging schemes, such as constant current charging, can also be used. One such implementation is described in more detail below.

Turning to FIG. 2, there is shown a further implementation of a battery charger 200. Battery charger 200 shares several features with battery charger 100, and similar features are indicated with the same reference signs. For clarity, power supply 130 is not shown in FIG. 2.

In battery charger 200, battery detection circuit 112 is indicated with dashed lines. Battery detection circuit 112 of battery charger 200 takes comprises a diode 122 and a capacitor 124 connected in series with auxiliary winding 106. Connection status signal 114 is taken at the junction between diode 122 and capacitor 124.

In battery charger 200, control circuitry 116 comprises a pulse generator 126 and a charging controller in the form of a flyback controller 128. Pulse generator 126 can take any suitable form, but in the implementation of FIG. 2, includes a low power analogue oscillator and a gate driver for FET 110. Pulse generator 126 is powered by DC power supply 130.

Without intending to be constrained by any particular power consumption values, it is desirable that at least some implementations enable the charger to reach, or at least approach, the target of Zero Standby Power Consumption (ZSPC), which is defined as being below 5 mW (average power) in standard IEC 62301:2011. The skilled person will appreciate that this standard represents a target rather than a strict requirement. To achieve this target, pulse generator 126 should consume less than 5 mW.

Both pulse generator 126 and flyback controller 128 receive, as control inputs, connection status signal 114.

As with battery charger 100, battery charger 200 is operable in a standby mode and a charging mode.

In use, battery charger 200 starts in standby mode, with battery 120 not being coupled for charging. Pulse generator 126 controls FET 110 such that a series of pulses are applied across primary winding 104. The pulses induce a corresponding current through secondary winding 108, and to a lesser extent, auxiliary winding 106.

Auxiliary winding 106 is in series with diode 122 and capacitor 124. As such, voltage induced in auxiliary winding 106 appears at diode 122. Because battery 120 is not providing voltage across secondary winding 108 while battery charger 200 is in standby mode, pulses induced in auxiliary winding 106 as a result of mirroring of pulses by secondary winding 104 are insufficient to cause flyback controller 128 to turn on. As such, connection status signal 114 remains low, indicating that battery 120 is not coupled to battery charger 200. Battery charger 200 therefore remains in the standby mode, in which flyback controller 128 remains powered down, while pulse generator 126 remains enabled.

Next, battery 120 is coupled to battery charger 200 for charging. Upon being coupled in this way, battery 120 presents a voltage across secondary winding 108 (for example, when a rectifier (not shown) between battery 120 and secondary winding 108 conducts). One way of coupling the voltage of battery 120 across secondary winding 108 via a rectifier is described below with reference to FIG. 3, but the skilled person will appreciate that other ways of detecting battery connection can also be employed.

The increase voltage that the secondary winding 108 needs to provide to conduct through the rectifier 138, as a result of the pulses applied to primary winding 104, causes the transformer magnetizing energy to flow through auxiliary winding 106, charging capacitor 124 through diode 122, thereby causing the voltage (and hence the value of connection status signal 114) to rise.

Once the voltage at capacitor 124 reaches a sufficient level, flyback controller 128 is enabled. The skilled person will be aware of several ways in which this may be achieved. For example, flyback controller 128 can be powered directly by DC power supply 130, and connection status signal 114 can be used as an enable signal that causes flyback controller 128 to start operating.

Where it is desirable to further reduce power consumption during standby, connection status signal 114 can be used to effectively wake up flyback controller 128. For example, connection status signal 114 can be used to enable a power supply to flyback controller 128, thereby switching it on.

Alternatively, and in the implementation of FIG. 2, connection status signal 114 can itself form the power supply to flyback controller 128. That is, while battery 120 is not connected to battery charger 200, connection status signal 114 does not provide significant power to flyback controller 128. Flyback controller 128 therefore remains “off”, and consumes effectively no power. When battery 120 is connected to battery charger 200, connection status signal 114 charges capacitor 124 via diode 122. Once the voltage of connection status signal 114 reaches a high enough value, flyback controller 128 is powered up by connection status signal 114, and begins controlling FET 110 to output pulses of the sort ordinarily used to drive a flyback transformer, such as transformer 102. The flyback pulses applied to primary winding 104 cause corresponding output pulses in secondary winding 108, as described above.

In the implementation of FIG. 2, the detection circuitry (i.e., diode 122 and capacitor 124) can be considered charge accumulating circuitry, the charge accumulating circuitry being configured to generate the connection status signal based on received pulses such that:
a voltage of the connection status signal as a result of the standby pulses when the battery is not connected is insufficient to cause the battery charger to switch from the standby mode into the charging mode; and
a voltage of the connection status signal as a result of the standby pulses when the battery is connected is sufficient to cause the battery charger to switch from the standby mode into the charging mode.

Connection status signal 114 going “high” simultaneously (or with a slight delay) causes pulse generator 126 to turn “off”. Pulse generator 126 can be turned off in any suitable manner. For example, a comparator can monitor connection status signal 114 against a reference voltage, and disable pulse generator 126 when connection status signal 114 is above the reference voltage.

Battery charger 200 uses a constant-current charging scheme, rather than a constant-current, constant-voltage charging scheme. Operation of this charging scheme will now be described with reference to a further implementation of a battery charger 300, as shown in FIG. 3. Battery charger 300 shares several features with battery charger 100, and similar features are indicated with the same reference signs. In effect, battery charger 300 is the same as battery charger 200, but includes a number of additional implementation details, which will now be described.

In FIG. 3, battery 120 includes a battery management system (BMS) 132 connected to battery cells 134. Battery cells 134 are a conventional array of lithium-ion cells, and will not be described in more detail. BMS 132 includes hardware that controls charging of battery cells 134, and may include, for example, a controller such as a microprocessor (not shown), voltage sensing circuitry (not shown), and/or any other suitable analogue and/or digital circuitry required to implement the described functions. Such circuitry is well-understood by the skilled person and so will not be described in more detail.

Battery 120 also includes a bypass field effect transistor (FET) 136 controlled by BMS 132 as described in more detail below.

Relative to battery charger 200, battery charger 300 includes a number of other elements. Conversion circuitry 118, shown in dotted outline in FIG. 3, includes an output rectifier 138 for rectifying an output of secondary winding 108, and an output capacitor 140 for smoothing the output of output rectifier 138.

Battery charger 300 includes first current feedback circuitry 142, which operates to provide, to flyback controller 128, feedback indicative of the present charging current, enabling flyback controller 128 to control the output to keep the current constant. The feedback is provided by way of an opto-coupler 143 to maintain galvanic isolation, in a manner well understood by the skilled person.

Battery charger 300 includes second current feedback circuitry 144, which operates to provide feedback on the current flowing through FET 110. Second current feedback circuitry enables flyback controller 128 to control FET 110 during charging, such that transformer 102 is not saturated and FET 110 is not overloaded.

The output of second current feedback circuitry 144 is also provided as an input to a first comparator 160. First comparator 160 is also provided with a first reference input 162. The output of first comparator 160 controls a switch 164, as described in more detail below.

FIG. 3 also shows one way in which pulse generator 126 can be implemented. Pulse generator 126 includes a controlled current source 166 coupled in series with a capacitor 168. Controlled current source 166 is enabled/disabled by connection status signal 114, such that pulse generator 126 generates pulses only when battery charger 100 is in the standby mode. The skilled person will appreciate that controlled current source 166 is just one example of a mechanism for controlled charging of capacitor 168, and that any other suitable circuitry can be used instead.

The junction between controlled current source 166 and capacitor 168 is coupled to control the gate of FET 110, by way of a switch 170. Switch 170 is controlled by the output of a second comparator 172. Second comparator 172 accepts as inputs a second reference 174 and to the junction between controlled current source 166 and capacitor 168. Connection status signal 114 is supplied as an enable signal to second comparator 172.

Pulse generator 126 has three states when battery charger 120 is in standby mode.

In the first state, FET 110 is off, switch 170 is open, and switch 164 is open. This is a charging state, during which capacitor 168 is charged by controlled current source 166, until the voltage of capacitor 168 exceeds that of second reference 174. This causes a change in the output of second comparator 172, causing pulse generator 126 to enter a second state in which switch 170 is closed.

In the second state, capacitor 168 charges the gate of FET 110 via switch 170, turning FET 110 on. Current through FET 110 starts increasing as a function of the DC power supply 130 voltage and the flyback primary inductance. When the current, as measured by second current feedback circuity 144, is higher than reference 162 connected to first comparator 160, the output of first comparator 160 changes state, causing switch 164 to close, thereby placing pulse generator 126 into the third state.

In the third state, switch 164 discharges capacitor 168 and the gate of FET 110. FET 110 turns off, and the falling voltage at capacitor 168 again changes the output of second comparator 172, such that pulse generator 126 returns to the first state.

The first, second, and third states are cycled through while battery charger 100 is in standby mode.

The skilled person will appreciate that forms of feedback can be provided to flyback controller 128, instead of (or in addition to) first current feedback circuitry 142 and second current feedback circuitry 144. For example, charging current regulation can be performed by flyback controller 128 based on feedback from primary winding 104. Any such feedback can be based on currents and/or voltages, depending upon the charging scheme (e.g., whether current- or voltage-based). Also, the skilled person will appreciate that current can be estimated from voltage, and so current feedback can take the form of a voltage (and vice versa). Any other available signal(s) can be used to estimate current, again either directly or indirectly.

Battery charger 300 includes a snubber or active clamp 146, which operates in a manner known to the skilled person, and will not be described in more detail.

In standby mode, battery charger 300 operates in the same way as was described for battery charger 200.

When battery 120 is coupled to charger 300 (when charger, BMS 132 senses the standby pulses from secondary winding 108. In response to sensing the pulses (and if BMS 132 determines that battery cells 134 require charging), BMS 132 controls bypass FET 136 to close, which in turn allows a voltage from battery cells 134 to be applied across secondary winding 108 via output rectifier 138. Auxiliary winding 106 mirrors the increase in voltage across secondary winding 108 during the conduction stage of output rectifier 138. This increased voltage across auxiliary winding 106 powers up flyback controller 128 and disables pulse generator 126, as was described in more detail above.

The pulses supplied to primary winding 104 as a result of flyback controller 128 controlling FET 110 causes output pulses within secondary winding 108. The output pulses are rectified by output rectifier 138, and filtered by output capacitor 140, to provide DC power to BMS 132. BMS 132 uses that DC power to both power itself, and to control charging of battery cells 134.

The skilled person will appreciate that this sequence will only take place if battery charger 100 is powered up (i.e., is plugged into a mains power supply and, if necessary, turned on) when battery 120 is coupled to it. In some implementations, BMS 132 can operate in a low-power or standby mode. If battery 120 is coupled to battery charger 100 when battery charger 100 is not powered up, then the lack of pulses at secondary winding 108 means BMS 132 will not be woken out of its low-power or standby mode, and hence will not close FET 110 in order to initiate the flyback conversion mode and hence the charging of battery 120.

If battery charger is powered up while battery 120 is coupled to it, the standby pulses described above will commence, causing pulses to appear at secondary winding 108. Those pulses wake BMS 132 out of its low-power/standby mode, and the switch the flyback charging mode continues as described above.

The skilled person will appreciate that any BMS may not be interposed between conversion circuitry 118 and battery cells 134 as shown in FIG. 3. Instead, BMS can be connected alongside battery cells 134, and configured for sensing factors related to charging of battery cells 134 (optionally including present cell voltage and charging current, for example), and controlling elements such as, for example, bypass FET 136.

Battery 120 is charged by battery charger 300 using a suitable constant current. The voltage required to maintain the constant current increases as battery cells 134 are charged. Once that voltage reaches a first threshold, BMS 132 disconnects battery cells 134 and opens bypass FET 136, such that charge current no longer flows through battery cells 134.

Flyback controller 128 determines that battery 120 is no longer being charged. This determination can be made in any suitable way, such as via feedback from auxiliary winding 106, or by way of a comparator (not shown) connected to an output of charger 300. Based on this determination, flyback controller 128 stops generating flyback control signals for FET 110.

When flyback controller 128 is shut down, output capacitor 140 needs to be discharged faster than the flyback controller capacitor, to avoid charging starting again as a result of mirroring of the voltage in output capacitor 140. The skilled person will understand that there are several ways in which this can be achieved.

For example, current leakage can be designed into the charger (by connecting a resistor, for example). The values of capacitor 124 and output capacitor 140 can be selected in conjunction with such designed current leakage to ensure that the voltage at output capacitor 140 falls fast enough relative to the voltage at capacitor 124 to ensure that charging does not restart.

An alternative approach is to add a circuit at the charger output that increases current drain so as to discharge output capacitor 140 once charging is stopped by BMS 132. There are multiple ways to achieve such controlled current leakage, including the use of a nonlinear impedance (e.g., a zener or voltage references) or comparators, or an optocoupler between the flyback controller power rail (i.e., connection status signal 114) and output capacitor 140.

A further alternative is to add a circuit within battery 120, controlled by BMS 132, to drive down the voltage of output capacitor 140 when charging of battery cells 134 is stopped by BMS.

Once the voltage of connection status signal 114 falls sufficiently, pulse generator 126 is re-enabled, and begins outputting standby pulses again, as described above. BMS 132 receives the pulses from charger 300 as described above, and depending upon the state of charge of battery cells 134, can elect to restart charging. In that case, BMS closes FET 136, and the process described above repeats.

A typical result of this sequence is a relatively long initial constant current charging period (assuming the battery has a relatively low initial charge), followed by one or more relatively brief constant current charging periods. When BMS 132 eventually determines that no further charge is required, FET 136 is kept open, and no further charging takes place.

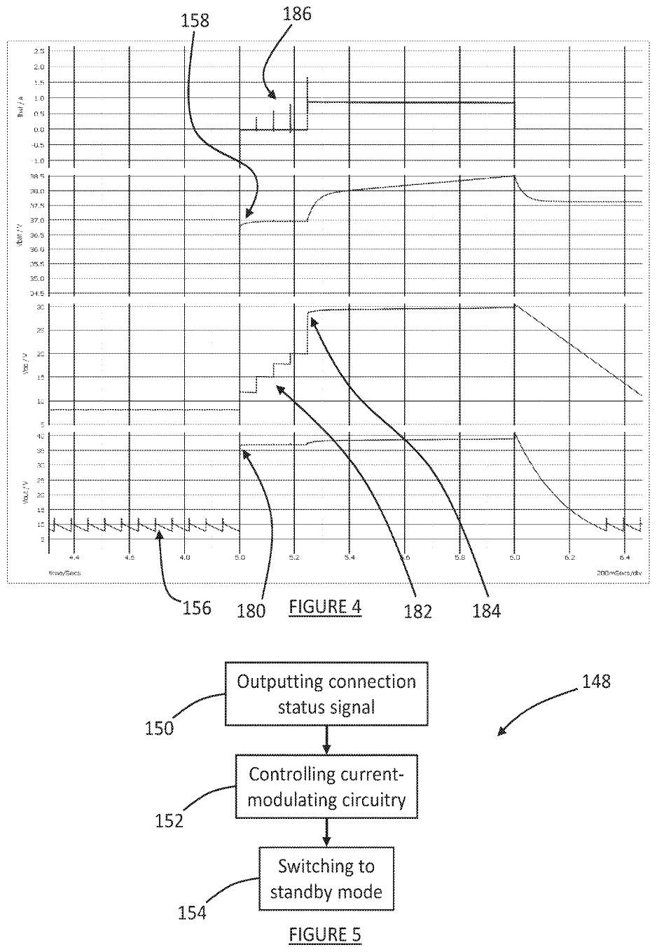

FIG. 4 is a signal diagram showing operation of the battery charger of FIG. 3. Four signal traces are shown:
1. The charge current ILOAD through battery 120.
2. Voltage Vbat of battery 120.
3. The voltage VDD of capacitor 124.
4. The output voltage Vout of charger 300.

In the period up to time 5.0, charger 300 is in standby mode. Due to the lack of voltage across secondary winding 108, mirroring of pulses in primary winding 104 generated by pulse generator 126 causes relatively small pulses 156 at the output of charger 300 (i.e., at capacitor 140).

Battery 120 is connected to battery charger 300 at time 5.0. BMS 132 detects pulses 156 at the output of charger 300, and in response (and assuming BMS 132 determines that battery 120 requires charging), closes bypass FET 136. This connects the voltage of battery cells 134 across secondary winding 108, as shown by the slight dip 158 in Vbat at this point and the increase 180 in voltage Vout at the output of charger 300.

The presence of the battery voltage across secondary winding 108 increases the voltage generated across auxiliary winding 106 due to mirroring of the standby pulses, as described above, which causes charging of capacitor 124 via diode 122. This is reflected in the stepping up 182 of VDD in FIG. 4. Because FET 136 is closed, battery 120 sees current pulses 186, as shown in the ILOAD signal in FIG. 4.

At about time 5.25, VDD rises to a voltage 184 that is high enough to power up flyback controller 128. Flyback controller 128 begins controlling FET 110 such that voltage across, and current though, primary winding 104 rise. When FET 110 is turned off, the sudden reduction in current through primary winding 104 generates a current in secondary winding 108. Flyback conversion of this type is well known to the skilled person, and will therefore not be described in further detail.

The output of secondary winding 108 is rectified by output rectifier 138 and filtered by output capacitor 140. The resultant filtered DC charges battery 120. The charging current is kept constant, as shown by the relatively constant value of ILOAD during charging between times 5.25 and 6.0 (approximately).

It will be appreciated that the actual charging time will generally be considerably longer than the period shown in FIG. 4. This is because FIG. 4 represents the behaviour of a simulated battery charger, for the purposes of explanation.

The constant current is controlled by flyback controller 128 based on feedback received via first current feedback circuitry 142. To maintain the constant current, the voltage applied to battery 120 needs to increase during charging, as shown by the rising value of Vbat between times 5.25 and 6 (approximately).

Once the voltage Vbat of battery 120 reaches a first threshold at 38.5 V at approximately time 6.0, battery cells 134 are disconnected by BMS 132 opening FET 136. The output voltage briefly increases after disconnection of battery cells 134. The resultant increase in voltage at flyback controller 128 is detected and flyback circuit 128 is disabled, as described above.

Vbat droops slightly as a result of the charging voltage being stopped.

The values of VDD and Vout fall due to discharge of the corresponding capacitors as described above

Once VDD has fallen sufficiently (at approximately time 6.3), pulse generator 126 commences operating, and low-voltage pulses 156 are again supplied by pulse generator 126 to primary winding 104.

If BMS 132 determines that further charging of battery cells 134 is required, the process is repeated as described above.

Turning to FIG. 5, there is shown a flowchart showing a method 148 for charging a battery. Method 148 uses a battery charger comprising a transformer having a primary winding and a first secondary winding. Battery chargers 100, 200, and 300 are examples of such battery chargers, although other suitable battery chargers and charger types can also be used.

Method 148 comprises outputting 150 a connection status signal based on an output of the first secondary winding, the output varying based on whether a battery is coupled to the battery charger for charging. Connection status signal 114, described above, is an example of such a connection status signal.

Method 148 comprises controlling 152 the current-modulating circuitry based on the connection status signal, thereby to control energisation of the primary winding, such that the battery charger is operable in:
a standby mode, in which standby pulses are generated in the primary winding; and
a charging mode, in which power pulses are generated in the primary winding, wherein the power pulses are of higher average power than the standby pulses.

Method 148 comprises, responsive to a change in the connection status signal upon coupling of the battery to the battery charger, switching 154 the battery charger from the standby mode to the charging mode.

Although implementations describe the use of flyback conversion, the skilled person will appreciate that other implementations may use different converter types. Non-limiting examples of such converter types include active clamp flyback converters, flyback converters with synchronous rectification, forward converters, flybuck converters, and bridge converters with transformer.

Although aspects have been described with reference to various implementations, the skilled person will appreciate that the invention may be embodied in many other forms.

1. A battery charger comprising:
a transformer comprising:
a primary winding; and
a first secondary winding;
current-modulating circuitry coupled in series with the primary winding;
battery detection circuitry coupled to the first secondary winding and configured to output a connection status signal; and
control circuitry coupled to receive the connection status signal, and to control the current-modulating circuitry at least partly in reliance on the connection status signal, thereby to control energisation of the primary winding;
wherein, when the battery charger is in a standby mode in which the control circuitry controls the current-modulating circuitry to generate standby pulses in the primary winding, a change in an output of the first secondary winding responsive to coupling of the battery to the battery charger causes the battery detection circuitry to change the connection status signal, the change in the connection status signal switching the battery charger from the standby mode to a charging mode, in which the control circuitry controls the current-modulating circuitry to generate power pulses in the primary winding, wherein the power pulses are of higher average power than the standby pulses.

2. The battery charger of claim 1, wherein the connection status signal comprises a voltage that increases responsive to the coupling of the battery to the battery charger.

3. The battery charger of claim 2, wherein the detection circuitry comprises charge accumulating circuitry, the charge accumulating circuitry being configured to generate the connection status signal based on the pulses such that:
a voltage of the connection status signal as a result of the standby pulses when the battery is not connected is insufficient to cause the battery charger to switch from the standby mode into the charging mode; and
a voltage of the connection status signal as a result of the standby pulses when the battery is connected is sufficient to cause the battery charger to switch from the standby mode into the charging mode.

4. The battery charger of claim 1, wherein:
the control circuitry includes a charging controller for controlling generation of the power pulses; and
the connection status signal is configured to power the charging controller during the charging mode.

5. The battery charger of claim 4, wherein the battery charger is configured to switch from the standby mode to the charging mode as a result of the charging controller being powered up due to an increase in voltage of the connection status signal.

6. The battery charger of claim 3, 5, wherein the charging controller includes:
a diode; and
a capacitor connected in series with the diode;
wherein the voltage of the connection status signal is a voltage generated at the capacitor based on current passing through the diode.

7. The battery charger of claim 1, wherein the control circuitry comprises an oscillator or a pulse generator for generating the standby pulses.

8. The battery charger of claim 7, wherein the oscillator or pulse generator is disabled when the battery charger is in the charging mode.

9. The battery charger of claim 7, wherein the oscillator or pulse generator comprises an analogue oscillator circuit.

10. The battery charger of claim 9, wherein the analogue oscillator circuit comprises an RC network.

11. The battery charger of claim 1, operable solely in a constant current charging mode.

12. The battery charger of claim 11, configured to receive feedback indicative of a charging current, wherein during the charging mode, the battery is charged solely in a constant current mode, the charge current being controlled based on the feedback.

13. The battery charger of claim 12, wherein, responsive to a battery management system stopping charging of the battery as a result of a charge voltage reaching a predetermined threshold, the connection status signal causes the battery charger to switch from the charging mode to the standby mode.

14. The battery charger of claim 13, configured such that the connection status signal causes the battery charger to repeatedly switch back and forth between the charging mode and the standby mode.

15. The battery charger of claim 1, comprising a second secondary winding, wherein the battery charger is configured to charge the battery via the second secondary winding.

16. The battery charger of claim 1, wherein the standby pulses in the primary winding induce corresponding pulses in an output of the battery charger, the corresponding pulses being detectable by a battery management system (BMS) of a battery upon coupling of the battery to the battery charger for charging.

17. A method of charging a battery using a battery charger comprising a transformer having a primary winding and a first secondary winding, the method comprising:
outputting a connection status signal based on an output of the first secondary winding, the output varying based on whether a battery is coupled to the battery charger for charging;
controlling a current-modulating circuitry based on the connection status signal, thereby to control energisation of the primary winding, such that the battery charger is operable in:
a standby mode, in which standby pulses are generated in the primary winding; and
a charging mode, in which power pulses are generated in the primary winding, wherein the power pulses are of higher average power than the standby pulses; and
responsive to a change in the connection status signal due to a change in the output of the first secondary winding upon coupling of the battery to the battery charger, switching the battery charger from the standby mode to the charging mode.

18. The method of claim 17, comprising generating the connection status signal based on the pulses such that:
a voltage of the connection status signal as a result of the standby pulses when the battery is not connected is insufficient to cause the battery charger to switch from the standby mode into the charging mode; and
a voltage of the connection status signal as a result of the standby pulses when the battery is connected is sufficient to cause the battery charger to switch from the standby mode into the charging mode.

19. The method of claim 17, comprising powering a charging controller of the battery charger with the connection status signal.

20. The method of claim 19, comprising switching from the standby mode to the charging mode as a result of the charging controller being powered up due to an increase in voltage of the connection status signal.

21-24. (canceled)
